(19) United States
(12) Patent Application Publication
(10) Pub. No.: US 2024/0227977 A1
(43) Pub. Date: Jul. 11, 2024

(54) RETURNABLE CLAMP FOR HANDLEBAR SWITCH MOUNTING

(71) Applicants: MINDA INDUSTRIES LIMITED, Gurgaon, Haryana (IN); Harley-Davidson Motor Company, Inc., Milwaukee, WI (US)

(72) Inventors: Kumar Desh DEEPAK, Gurgaon, Haryana (IN); Rajiv RATHORE, Gurgaon, Haryana (IN); Ganeswar BEURA, Gurgaon, Haryana (IN); Benjamin HYNES, Milwaukee, WI (US); Patrick MCKEON, Milwaukee, WI (US)

(73) Assignees: UNO Minda Limited, Gurgaon, Haryana (IN); Harley-Davidson Motor Company, Inc., Milwaukee, WI (US)

(21) Appl. No.: 18/559,615

(22) PCT Filed: May 6, 2022
(86) PCT No.: PCT/IN2022/050438

§ 371 Date: Nov. 8, 2023

(30) Foreign Application Priority Data
May 8, 2021 (IN) 202111020925

(51) Int. Cl. B62K 21/14

(52) U.S. Cl. CPC B62K 21/14

(57) ABSTRACT

A clamp assembly for a handlebar of a vehicle comprises a first clamp body and a second clamp body. The first clamp body and the second clamp body are pivotally mounted around the handlebar. The first clamp body and the second clamp body are hinged at one end using a hinge pin. A resilient means is mounted at the hinge pin and adapted to be coupled with the first clamp body and the second clamp body. The resilient means is adapted to provide a torsional force for moving the first and second clamp body from a closed position to an open position of the clamp assembly. The clamp assembly is adapted with a switch assembly. A stopper pin is configured on the first clamp body to secure the switch assembly on the clamp assembly.

### TECHNICAL FIELD

The present disclosure in general, relates to a field of automobile engineering. Particularly, but not exclusively, the disclosure relates to a clamp assembly for a vehicle. Further, embodiments of the disclosure, disclose a switch housing mounted to the clamp assembly of a handlebar of the vehicle.

### BACKGROUND OF DISCLOSURE

The information in this section merely provides background information related to the present disclosure and may not constitute prior art(s).

A switch assembly is usually mounted on the handlebar/dashboard of the vehicle such that, the switches embedded in the assembly are proximal and easily accessible by the user. The switch assembly is operated by the user to actuate various functions of the vehicle which aid in safer means of commuting. The switches in the switch assembly are configured for various functions such as, but not limited to, horn, turn-indicators, engine ignition, pass-by light, cruise control etc. which form essential requirements in any vehicle.

Conventionally, the switch assembly is mounted over the handlebar with the help of plurality fasteners and at least one metallic insert. Switch assemblies are basically made of two halves or two components that are brought together and joined by suitable means. The metallic inserts are insert molded in one half of the switch housing. The mounting screws are fastened in order to bring the two halves of switch assembly together. This secures the switch assembly around the handlebar and prevents it from dismantling. However, the switch assembly is free to slide on the handlebar and also to rotate about the axis of the handlebar. This causes interference between the two-switch housing and handlebar. Additionally, the switch assembly tends to rotate due to vibrations of the vehicle, wherein the fasteners over a period of time tend to lose out on torque and the switch assembly loses its grip on the handlebar. In order to curb the movement or rotation of the switch assembly on the handlebar, a hole is drilled in the handlebar and the metallic insert is inserted to prevent the switch housing from rotating on the handlebar. The metallic insert is used to stop the switch assembly from sliding and rotating on the handlebar, thereby securing the position of the switch housing over the handlebar. On the contrary, drilling holes on the handlebar reduces the stress applied by the fasteners and inserts. However, drilling of holes reduces the strength of the handlebar and the handlebar fails in the application of additional stress. This may lead to potential failures of the handlebar over prolonged usage of the handlebar.

Due to the provision of a metallic insert in any of the two halves of the housing, the switch housing position is fixed with respect to the handlebar. This arrangement of the switch housing restricts the user from customizing its position with respect to the handlebar. Further, in the assembly line or during maintenance, the mounting screws are torqued to the maximum in order to obtain a stronger joint. However, torqueing the mounting screws to the maximum extent induces stress on the screw as well as the switch housing, after a period of time. This induced stress results in the self-locking of the mounting screws and also reduces the joint strength between the halves of the switch housing.

Further, it is known in the art to provide a clamp assembly to curb the movement or rotation of switch assembly on the handlebar. The clamp assembly may generally comprise two halves joined by screws or the like to mount the switch assembly on the handlebar. However, the assembling process of the switch module comprises such clamp assembly with handlebar is very complex and time-consuming. It has to be noted that clamps remain always closed due to their own weight which makes it difficult to position or engage in a suitable manner and makes the assembly rigid. Thus, because of the rigid nature of the clamp assembly, the assembling or disassembling of such clamp assembly with respect to the handlebar could result in damage to the switch assembly or handlebar.

In light of the foregoing discussion, there is a need in the art to develop a clamp assembly for mounting the switching assembly on the handlebar of the vehicle which can overcome one or more limitations stated above or any other limitations associated with the prior art.

The present disclosure is directed to overcome one or more limitations stated above or any other limitations associated with the prior art.

### OBJECTIVES OF DISCLOSURE

The main objective of the present disclosure is to provide a clamp assembly which is configured to secure a switch assembly of the handlebar of the vehicle.

Another objective of the present disclosure is to provide a resilient means adapted to be coupled with a first clamp body at one end and with a second clamp body at other end.

One more objective of the present disclosure is to provide a stopper pin which secures the switch assembly on the clamp assembly.

One more objective of the present disclosure is to provide a plurality of grooves at the first clamp body and the second clamp body configured to restrict the movement of the resilient means.

### SUMMARY OF THE DISCLOSURE

One or more shortcomings of the prior art are overcome by a mechanism and assembly as claimed and additional advantages are provided through the mechanism and assembly as claimed in the present disclosure. Additional features and advantages are realized through the techniques of the present disclosure. Other embodiments and aspects of the disclosure are described in detail herein and are considered a part of the claimed disclosure.

In one non-limiting embodiment of the present disclosure, a clamp assembly for a handlebar of a vehicle is disclosed. The clamp assembly comprises a first clamp body and a second clamp body, wherein the first clamp body and the second clamp body are pivotally mounted around a handlebar of the vehicle. Further, a plurality of first projections is defined on the first clamp body and a plurality of second projections is defined on the second clamp body. The plurality of first projections and the plurality of second projections are configured with each other by a hinge pin. A plurality of grooves is defined on the plurality of first projections and the plurality of second projections. A resilient member having a first end and a second end is disclosed. The resilient means is adapted to be coupled with the first clamp body at the first end and with the second clamp body at the second end.

In an embodiment of the present disclosure, the clamp assembly comprises at least one flange defined on the first clamp body and the second clamp body, at least one fastener provided on at least one flange of the first clamp body and the second clamp body and at least one protrusion defined on the first clamp body and the second clamp body. The at least one protrusion is configured to secure the clamp assembly with a switch assembly of the handlebar of the vehicle.

In an embodiment of the present disclosure, the resilient means is mounted on the hinge pin and the hinge pin is configured to enable hinging action between the first clamp body and the second clamp body around the handlebar.

In an embodiment of the present disclosure, the resilient means is a spiral torsional spring.

In an embodiment of the present disclosure, the plurality of grooves are configured to restrict the movement of the resilient means.

In an embodiment of the present disclosure, the clamp assembly comprises at least one stopper pin configured on at least one of the first clamp body and the second clamp body. The stopper pin secures the switch assembly on the clamp assembly.

In an embodiment of the present disclosure, the first projections and the second projections form an integral part of the first clamp body and the second clamp body.

In an embodiment of the present disclosure, the first clamp body is defined with the plurality of first projections at one end and at least one flange on the other end of the first clamp body. The second clamp body is defined with the plurality of second projections at one end and at least one flange on the other end of the second clamp body.

In an embodiment of the present disclosure, at least one fastener provided on at least one flange is configured to induce a compressive force on the handlebar by the first clamp body and the second clamp body.

In an embodiment of the present disclosure, the clamp assembly mounted on the handlebar restricts rotational movement of the switch assembly.

It is to be understood that the aspects and embodiments of the disclosure described above may be used in any combination with each other. Several of the aspects and embodiments may be combined together to form a further embodiment of the disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF FIGURES

The novel features and characteristics of the disclosure are set forth in the description. The disclosure itself, however, as well as a preferred mode of use, further objectives and advantages thereof, will best be understood by reference to the following description of an illustrative embodiment when read in conjunction with the accompanying drawings. One or more embodiments are now described, by way of example only, with reference to the accompanying drawings wherein like reference numerals represent like elements and in which:

FIG. 1 illustrates an exploded view of a clamp assembly for a vehicle in accordance with an embodiment of the present disclosure.

FIG. 2 illustrates an exploded view of a clamp assembly for a vehicle in accordance with an embodiment of the present disclosure.

FIG. 3 illustrates a perspective view of a hinge pin assembly of the clamp assembly for a vehicle in accordance with an embodiment of the present disclosure.

FIG. 4 illustrates a perspective view of the clamp assembly for a vehicle in an open position in accordance with an embodiment of the present disclosure.

FIG. 5 illustrates a perspective view of the clamp assembly for a vehicle in an intermediate position in accordance with an embodiment of the present disclosure.

FIG. 6 illustrates a perspective view of the clamp assembly for a vehicle in an intermediate position in accordance with an embodiment of the present disclosure.

FIG. 7 illustrates a perspective view of the clamp assembly for a vehicle in a closed position in accordance with an embodiment of the present disclosure.

Skilled artisans will appreciate that elements in the drawings are illustrated for simplicity and have not necessarily been drawn to scale. For example, the dimensions of some of the elements in the drawings may be exaggerated relative to other elements to help to improve understanding of embodiments of the present disclosure.

### DETAILED DESCRIPTION OF THE DISCLOSURE

While the disclosure is susceptible to various modifications and alternative forms, specific embodiment thereof has been shown by way of example in the figures and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

Before describing in detail embodiments, it may be observed that the novelty and inventive step that are in accordance with the present disclosure resides in a clamp assembly for a vehicle. It is to be noted that a person skilled in the art can be motivated from the present disclosure and modify the various constructions of an integrated safety unit. However, such modification should be construed within the scope and spirit of the disclosure. Accordingly, the drawings are showing only those specific details that are pertinent to understanding the embodiments of the present disclosure so as not to obscure the disclosure with details that will be readily apparent to those of ordinary skill in the art having benefit of the description herein.

The terms “comprises”, “comprising”, or any other variations thereof, are intended to cover a non-exclusive inclusion, such that a setup, device that comprises a list of components does not include only those components but may include other components not expressly listed or inherent to such setup or device. In other words, one or more elements in a system or apparatus proceeded by “comprises . . . a” does not, without more constraints, preclude the existence of other elements or additional elements in the system or apparatus.

Reference will now be made to the exemplary embodiments of the disclosure, as illustrated in the accompanying drawings. Wherever possible same numerals will be used to refer to the same or like parts.

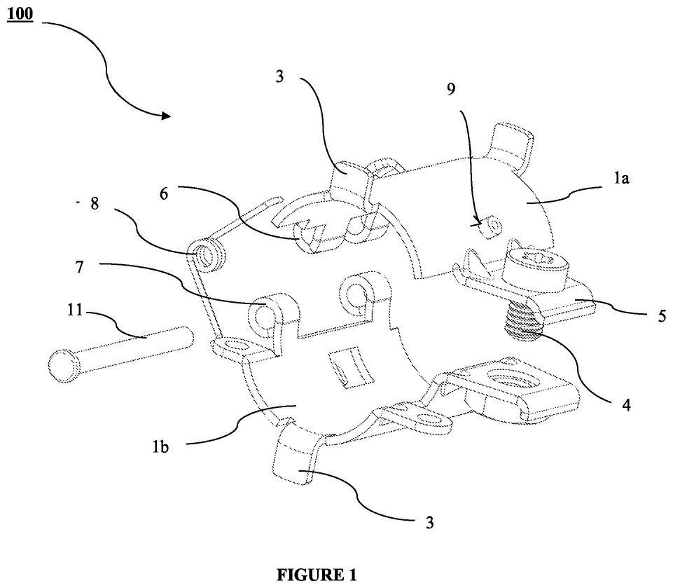

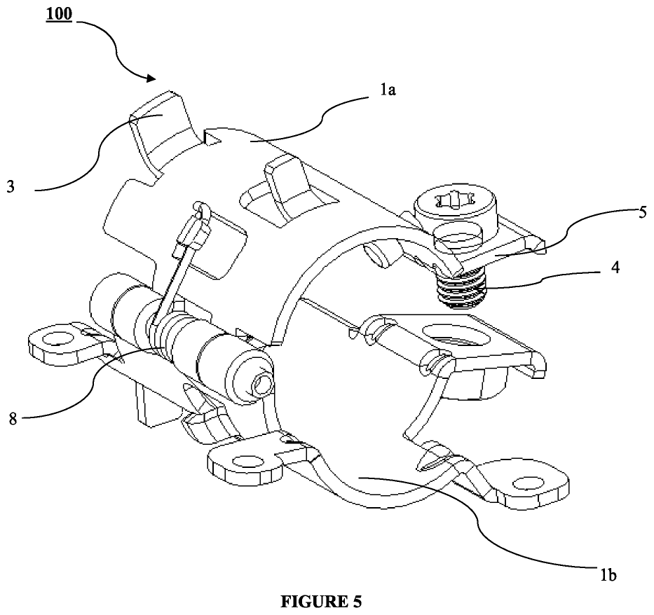

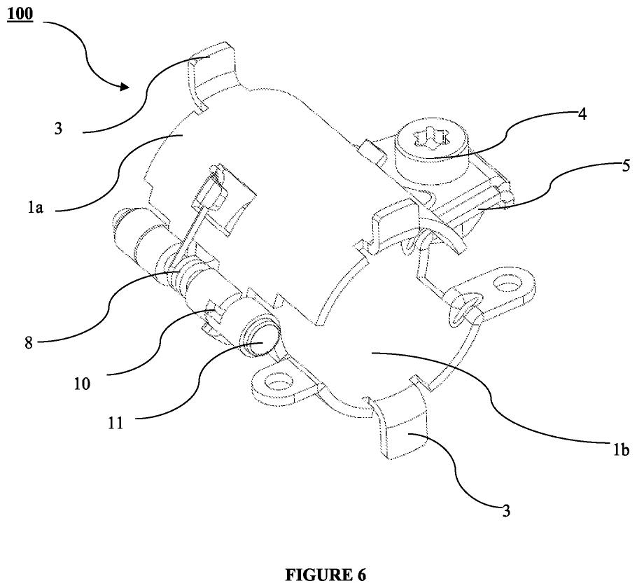

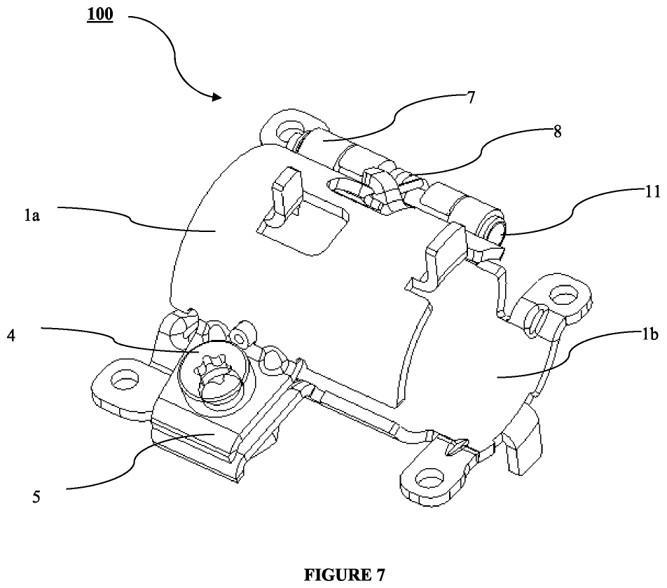

Embodiments of the disclosure are described in the following paragraphs with reference to FIGS. 1 to 7. In the figures, the same element or elements which have the same functions are indicated by the same reference signs. It is to be noted that, the vehicle is not illustrated in the figures for the purpose of simplicity. One skilled in the art would appreciate that the assembly and method as disclosed in the present disclosure can be used in any vehicle including but not liming to a bicycle, a moped passenger car, heavy vehicles, light duty vehicles or any other vehicle.

FIG. 1 is an exemplary embodiment of the present disclosure which illustrates an exploded view of a clamp assembly (100) for a vehicle. The clamp assembly (100) is mounted on a handlebar of the vehicle. The clamp assembly (100) comprises a first clamp body (1a) and a second clamp body (1b). The first clamp body (1a) is provided with a plurality of first projections (6) on one side, while a plurality of second projections (7) are provided on the second clamp body (1b) on the same side. The first projections (6) and the second projections (7) are on the same plane and same side of the first clamp body (1a) and the second clamp body (1b). The first clamp body (1a) and the second clamp body (1b) with their first projections (6) and the second projections (7) are in line with each other upon assembly. Further, the first projections (6) mate with the second projections (7) to form a hinge joint, thereby enabling the clamp assembly (100) to pivot about a handlebar axis (not shown in figures). In an embodiment of present disclosure, the first projections (6) and the second projections (7) form an integral part of the first clamp body (1a) and the second clamp body (1b). In an embodiment of the present disclosure, the first projections (6) and the second projections (7) are integrated to the first clamp body (1a) and the second clamp body (1b) by at least one of welding, soldering, brazing, casting, or any other method that serves the purpose.

In an embodiment of the present disclosure, the first clamp body (1a) is provided with the first projections (6) at one end and at least one flange (5) on the other end of the first clamp body (1a). The second clamp body (1b) is provided with the second projections (7) at one end and at least one flange (5) on the other end of the second clamp body (1b). The first clamp body (1a) and the second clamp body (1b) are pivotally mounted around the handlebar of the vehicle such that, the at least one flange (5) configured to the first clamp body (1a) and the second clamp body (1b) are in-line with one another. In an embodiment of the present disclosure, the at least one flange (5) is configured to the first clamp body (1a) and the second clamp body (1b) by at least one of welding, soldering, brazing, casting, forging, or any other method that serves the purpose. In an embodiment of the present disclosure, at least one flange (5) is manufactured by at least one of casting, blanking, punching, forging, or any other method that serves the purpose. In an embodiment of the present disclosure, the flange (5) is at least one slip-on flange, flat flange, welding neck flange, threaded flange, or any other flange that serves the purpose.

In an embodiment, the flange (5) is configured to receive at least one fastener (4). The at least one fastener (4) is fixed to the at least one flange (5) of the first clamp body (1a) and the second clamp body (1b). Fastening of the at least one fastener (4) fixed to at least one flange (5) on either of the first clamp body (1a) and the second clamp body (1b) induces a compressive force on at least one flange (5), thereby bringing the first clamp body (1a) and the second clamp body (1b) closer, whilst by gripping to the handlebar of the vehicle. Further, the compressive force induces compressive stress on the first clamp body (1a) and the second clamp body (1b). Due to compressive stress on the first clamp body (1a) and the second clamp body (1b), the clamp assembly (100) exerts circumferential pressure on the handlebar thereby tightening the grip of the clamp assembly (100) around the handlebar of the vehicle. In an embodiment of the present disclosure, the fastener (4) is at least one of a nut, a screw, a bolt, a threaded washer, a rivet, a grommet, or any fasteners in combination that serves the purpose.

In an embodiment of the present disclosure, the first clamp body (1a) and the second clamp body (1b) are provisioned with at least one protrusion (3). The protrusions (3) are provided on the first clamp body (1a) and the second clamp body (1b) configured to secure the clamp assembly (100) with a switch assembly.

In an embodiment of the present disclosure, referring to FIGS. 1-7, the first clamp body (1a) and the second clamp body (1b) may be hinged at one end by a hinge pin (11). The hinge pin (11) may enable hinging action between the first clamp body (1a) and the second clamp body (1b) around the handlebar. In another embodiment of the present disclosure, a resilient means (8) is mounted on the hinge pin (11) and adapted to be coupled with the first clamp body (1a) at one end and the second clamp body (1b) at another end. The resilient means (8) is adapted to provide a torsional force for moving the first clamp body (1a) and the second clamp body (1b) from a closed position to an open position of the clamp assembly. In another embodiment of the present disclosure, the resilient means (8) is a spiral torsional spring. In yet another embodiment of present disclosure, the resilient means (8) is adapted to be coupled with the first clamp body (1a) and with the second clamp body (1b) by at least one of welding, soldering, brazing and any other means of joining.

In an embodiment of present disclosure, one end of the resilient means (8) is mounted at the first clamp body (1a) and another end of the resilient means is joined with the second clamp body (1b) by at least one of welding, soldering, brazing and any other means of joining and vice versa. In yet another embodiment of present disclosure, the resilient means (8) is adapted to be mounted at the first clamp body (1a) and the second clamp body (1b) at predetermined positions. In yet another embodiment of present disclosure, at least one end of resilient means is configured to move in a lateral direction upon movement of the first clamp body (1a) with the second clamp body (1b).

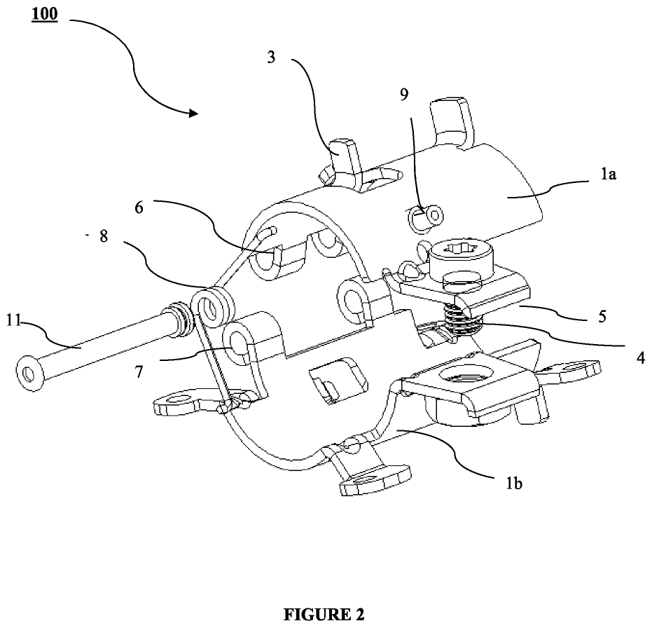

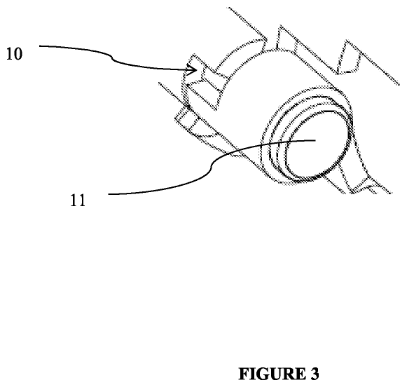

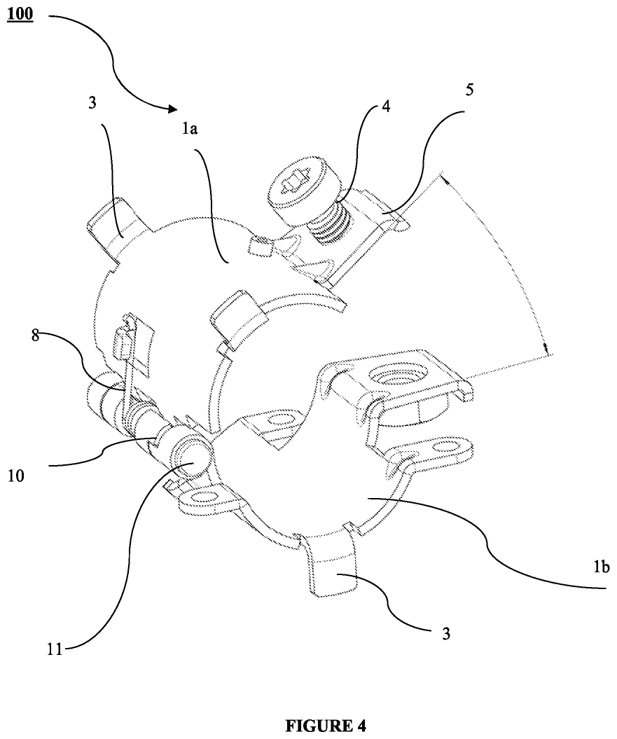

In an embodiment of present disclosure, referring to FIGS. 3 and 4, a plurality of grooves (10) are provided at the first projections (6) and the second projections (7). Referring to FIGS. 2-4, the plurality of grooves (10) arc configured to restrict the movement of the resilient means (8) up to a certain angle when the at least one fastener (4) is disengaged. The resilient means (8) is configured to open the clamp assembly (100) when the at least one fastener (4) is disengaged. Therefore, the resilient means (8) ensures the returnability of the clamp assembly in an open position when the at least one fastener (4) is disengaged.

In an embodiment of the present disclosure, the clamp assembly comprises at least one stopper pin (9) configured on the first clamp body (1a) and the second clamp body (1b). The stopper pin (9) secures the switch assembly on the clamp assembly (100). The stopper pin (9) restricts the rotary movement of the switch assembly on the handlebar. In another embodiment of the present disclosure, a plurality of stopper pins (9) are configured on the first clamp body (1a) and the second clamp body (1b) for securing the switch assembly on the clamp assembly (100) and restrict rotary movement of the switch assembly on the handlebar.

In an embodiment of the present disclosure, the clamp assembly (100) is pivoted and assembled over the handlebar by expanding the first clamp body (1a) and the second clamp body (1b) to mount around the handlebar. In an embodiment of the present disclosure, the material for manufacturing the clamp assembly (100) is at least one of aluminum, copper, steel, plastic, fiber-reinforced plastic, alloys or any other material that serves the purpose. In an embodiment of the present disclosure, the handlebar of the vehicle is configured to a fork assembly (not shown in the figure) to steer the vehicle. In an embodiment of present disclosure, the handlebar is at least one of a solid shaft, a hollow shaft, a clip-on handlebar or any other handlebar configuration which serves the purpose of mounting a switch assembly and steering of the vehicle. In an embodiment of the present disclosure, the handlebar is at least one of plastic, fibre-reinforced plastic, metal, wood, alloy or any other material that serves the purpose.

Accordingly, the clamp assembly as disclosed in the present disclosure is economical to manufacture, easy to assemble and less time-consuming with respect to existing arts. Further, the resilient means accommodating the opening of the clamp when the at least one fastener is disengaged. Furthermore, it helps in easy assembling or disassembling of the clamp assembly on the handlebar and also protects the switch and handlebar from getting damaged.

While considerable emphasis has been placed herein on the particular features of this disclosure, it will be appreciated that various modifications can be made and that many changes can be made in the preferred embodiments without departing from the principles of the disclosure. These and other modifications in the nature of the disclosure or the preferred embodiments will be apparent to those skilled in the art from the disclosure herein, whereby it is to be distinctly understood that the foregoing descriptive matter is to be interpreted merely as illustrative of the disclosure and not as a limitation.

REFERAL NUMERICALS

| PARTICULARS | REFERRAL NUMERAL |
|---|---|
| First clamp body | 1a |
| Second clamp body | 1b |
| At least one protrusion | 3 |
| Fastener | 4 |
| Flange | 5 |
| First projection | 6 |
| Second projection | 7 |
| Resilient means | 8 |
| Stopper pin | 9 |
| Plurality of grooves | 10 |
| Hinge pin | 11 |
| Clamp assembly | 100 |

### EQUIVALENTS

The embodiments herein and the various features and advantageous details thereof are explained with reference to the non-limiting embodiments in the description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles and the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

1. A clamp assembly for a handlebar of a vehicle, the clamp assembly comprising:
a first clamp body and a second clamp body, wherein the first clamp body and the second clamp body are pivotally mounted around the handlebar of the vehicle;
a plurality of first projections defined on the first clamp body and a plurality of second projections defined on the second clamp body, wherein the plurality of first projections and the plurality of second projections are configured with each other by a hinge pin;
a plurality of grooves defined on the plurality of first projections and the plurality of second projections; and
a resilient member having a first end and a second end, wherein the resilient means adapted to be coupled with the first clamp body at the first end and with the second clamp body at the second end.

2. The clamp assembly as claimed in claim 1, comprises:
at least one flange defined on the first clamp body and the second clamp body;
at least one fastener provided on at least one flange of the first clamp body and the second clamp body; and
at least one protrusion defined on the first clamp body and the second clamp body configured to secure the clamp assembly with a switch assembly of the handlebar of the vehicle.

3. The clamp assembly as claimed in claim 1, wherein the resilient means is mounted on the hinge pin and the hinge pin is configured to enable hinging action between the first clamp body and the second clamp body around the handlebar.

4. The clamp assembly as claimed in claim 1, wherein the resilient means is a spiral torsional spring.

5. The clamp assembly as claimed in claim 1, wherein the plurality of grooves are configured to restrict the movement of the resilient means.

6. The clamp assembly as claimed in claim 1, comprises at least one stopper pin configured on at least one of the first clamp body and the second clamp body, wherein the stopper pin secures the switch assembly on the clamp assembly.

7. The clamp assembly as claimed in claim 1, wherein the first projections and the second projections form an integral part of the first clamp body and the second clamp body.

8. The clamp assembly as claimed in claim 1, wherein the first clamp body is defined with the plurality of first projections at one end and at least one flange on the other end of the first clamp body, whereby the second clamp body is defined with the plurality of second projections at one end and at least one flange on the other end of the second clamp body.

9. The clamp assembly as claimed in claim 1, wherein at least one fastener provided on at least one flange is configured to induce a compressive force on the handlebar by the first clamp body and the second clamp body.

10. The clamp assembly as claimed in claim 1, wherein the clamp assembly mounted on the handlebar restricts rotational movement of the switch assembly.
